(19) United States
(12) Patent Application Publication
(10) Pub. No.: US 2024/0267605 A1
(43) Pub. Date: Aug. 8, 2024

(54) IMAGING DEVICE

(71) Applicant: NIDEC PRECISION CORPORATION, Tokyo (JP)

(72) Inventor: Yuusuke SUZUKI, Tokyo (JP)

(21) Appl. No.: 18/429,430

(22) Filed: Feb. 1, 2024

(30) Foreign Application Priority Data
Feb. 8, 2023 (JP) 2023-017671

(51) Int. Cl. H04N 23/56; H04N 23/51; H04N 23/55; H04N 23/71

(52) U.S. Cl. CPC H04N 23/56; H04N 23/51; H04N 23/55; H04N 23/71

(57) ABSTRACT

An imaging device includes an imaging element that receives subject light through an optical member, an illuminator including an illumination light source that emits illumination light to illuminate a subject and a substrate on which the illumination light source is located, and a first light shield surrounding the illumination light source on the substrate. The first light shield has a through-hole receiving the illumination light source. The through-hole extends in a direction along an optical axis of the illumination light source. The through-hole has a wall surface to block a part of the illumination light emitted by the illumination light source.

### RELATED APPLICATIONS

The present application claims priority to Japanese Application Number 2023-017671, filed Feb. 8, 2023, the disclosure of which is hereby incorporated by reference herein in its entirety.

### BACKGROUND

### Technical Field

The present invention relates to an imaging device.

### Description of the Background

Surveillance cameras are installed at various places such as nursing care facilities, hospitals, factories, and stores for crime and disaster prevention. Such surveillance cameras, which are imaging devices, may be used in dark environments such as a room receiving no direct or indirect sunlight and a room with no lightening equipment being on.

Patent Literature 1 describes a private room monitoring system. The system includes a sensor unit with an optical block including projectors that project infrared laser beams into a room, a light-emitting diode (LED) diffused light illuminator that emits infrared light to the room as illumination light, an imaging device that captures images of the room, and an illuminometer. To obtain images, the imaging device captures an image of a group of bright spots projected into the room by the projectors and also captures an image of the room illuminated by the LED diffused light illuminator. The illuminometer is located adjacent to the imaging device. In response to the illuminometer receiving the amount of light exceeding a predetermined value due to ambient light, the sensor unit provides a notification indicating that monitoring cannot be performed normally.

### CITATION LIST

### Patent Literature

Patent Literature 1: WO 2018/038087

### BRIEF SUMMARY

However, the structure described in Patent Literature 1 may allow light emitted from the projectors or the LED diffused light illuminator to be diffusely reflected in the optical block and enter various light-receiving sensors, and affect signals output by the light-receiving sensors.

An imaging device according to an aspect of the present invention includes an imaging element that receives subject light through an optical member, an illuminator including an illumination light source that emits illumination light to illuminate a subject and a support on which the illumination light source is located, and a first light shield surrounding the illumination light source on the support. The first light shield has a through-hole receiving the illumination light source. The through-hole extends in a direction along an optical axis of the illumination light source. The through-hole has a wall surface to block a part of the illumination light emitted by the illumination light source.

The imaging device according to the above aspect of the present invention can reduce entry of illumination light emitted from the illumination light source into the imaging element.

### BRIEF DESCRIPTION OF DRAWINGS

FIG. 1 is an external perspective view of an imaging device according to an embodiment.

FIG. 2 is an external perspective view of a front case.

FIG. 3 is an internal perspective view of the imaging device.

FIG. 4 is a cross-sectional view of the imaging device taken along line A-A in FIG. 1.

FIG. 5A is a cross-sectional view of the imaging device taken along line B-B in FIG. 1.

FIG. 5B is a cross-sectional view of the imaging device taken along line C-C in FIG. 1.

FIG. 6A is a partially enlarged view of the imaging device shown in the internal perspective view in FIG. 3.

FIG. 6B is a partially enlarged view of the imaging device shown in the cross-sectional view in FIG. 5B.

FIG. 7A is a partially enlarged view of the imaging device shown in the external perspective view in FIG. 2.

FIG. 7B is a partially enlarged view of the imaging device shown in the cross-sectional view in FIG. 4.

FIG. 8 is a partially enlarged view of the imaging device shown in the cross-sectional view in FIG. 5A.

FIG. 9 is a cross-sectional view of a first light shield in a first modification showing the shape.

FIG. 10A is an external perspective view of a first light shield in a second modification showing the shape.

FIG. 10B is a cross-sectional view of the first light shield in the second modification showing the shape.

FIG. 11A is an external perspective view of a first light shield in a third modification showing the shape.

FIG. 11B is a cross-sectional view of the first light shield in the third modification showing the shape.

FIG. 12 is a cross-sectional view of a first light shield in another example of the embodiment showing the shape.

### DETAILED DESCRIPTION

An imaging device according to one or more embodiments of the present invention will now be described in detail with reference to the drawings.

The imaging device may have any use and may be installed at, for example, a hospital, a nursing care facility, a factory, and a store as a surveillance camera or as a monitoring camera. The imaging device detects the brightness of the surrounding external environment with an illuminometer and can be switched between a normal imaging mode and a low-light imaging mode based on the detected brightness. Imaging in the normal imaging mode is performed using light incident on an imaging optical system when the external environment is bright. Imaging in the low-light imaging mode is performed using illumination light emitted when the external environment is dark to allow imaging of a subject using the illumination light.

### Overall Structure of Imaging Device 10

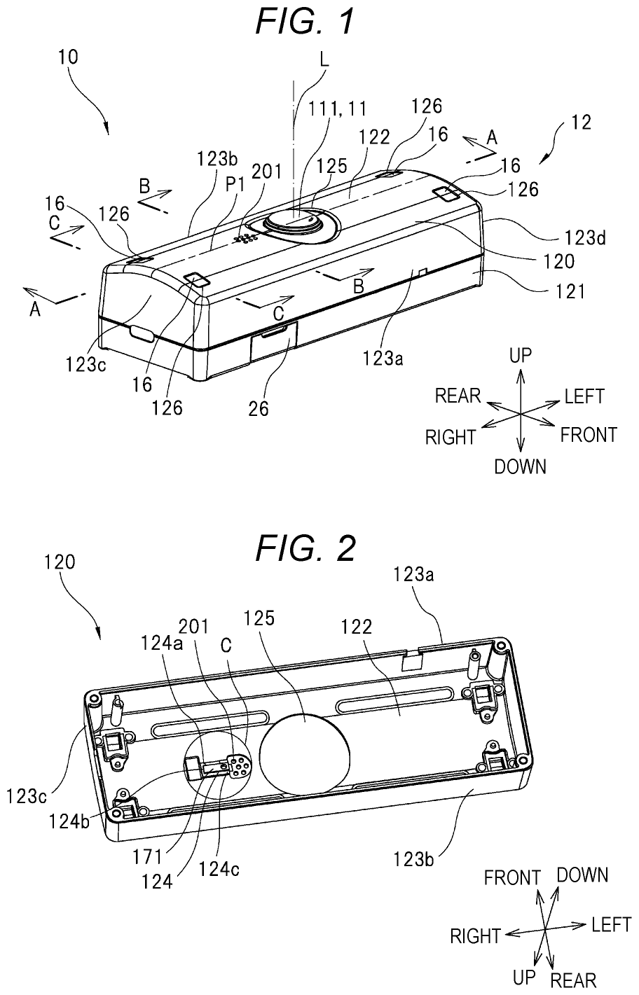

FIG. 1 is an external perspective view of an imaging device 10. The imaging device 10 includes a camera module 11, a housing (outer case) 12, illuminators 16, and a memory slot 26.

### Housing 12

The housing 12 includes a front case 120 and a rear case 121. The front case 120 includes a rectangular or substantially rectangular top plate 122 and sidewall plates 123a, 123b, 123c, and 123d that adjoin the sides of the top plate 122. The top plate 122 and the sidewall plates 123a, 123b, 123c, and 123d are integrally formed from a synthetic resin. The sidewall plate 123a adjoins one long side of the top plate 122. The sidewall plate 123b adjoins the other long side of the top plate 122. The sidewall plate 123c adjoins one short side of the top plate 122. The sidewall plate 123d adjoins the other short side of the top plate 122.

Hereafter, the direction in which the front case 120 in the housing 12 is located may be referred to as being upward, the direction in which the rear case 121 is located as being downward, the direction in which the sidewall plate 123a is located as being frontward, the direction in which the sidewall plate 123b is located as being rearward, the direction in which the sidewall plate 123c is located as being rightward, and the direction in which the sidewall plate 123d is located as being leftward.

The top plate 122 of the front case 120 is an outer plate intersecting with an optical axis L of a lens 111 included in the camera module 11. The top plate 122 includes a middle portion (in other words, a first reference position P1) protruding upward with respect to its front and rear ends in the front-rear direction. In other words, the top plate 122 has front and rear end surfaces inclined toward the middle portion.

The top plate 122 has a case opening 125 and four illumination openings 126. The case opening 125 has a circular or substantially circular shape centered on a point through which the optical axis L of the lens 111 extends. The lens 111 (described later) is placed in the case opening 125. In the present embodiment, the optical axis L of the lens 111 extends through the center of the top plate 122.

The optical axis L of the lens 111 may not extend through the center of the top plate 122. The optical axis L of the lens 111 may extend through a point shifted rightward or leftward from the center of the top plate 122, or may extend through a point shifted frontward or rearward from the center of the top plate 122.

The top plate 122 has the illumination openings 126 in its four corners. The illumination openings 126 allow passage of illumination light emitted from the illuminators 16 (described later) in the housing 12 to be output from the imaging device 10. As shown in FIG. 1, the top plate 122 has four illumination openings 126 in total, with two in its right portion (one at the front and the other at the rear) and the other two in its left portion (one at the front and the other at the rear). In other words, the top plate 122 has the four illumination openings 126 on the surfaces inclined toward the middle portion. The positions of the illumination openings 126 are not limited to the positions shown in the figure and are determined as appropriate based on the positions of the illuminators 16. The illumination openings 126 may not be four illumination openings 126, but may be three or fewer or five or more illumination openings 126. The number of illumination openings 126 is determined based on the number of illuminators 16 in the imaging device 10.

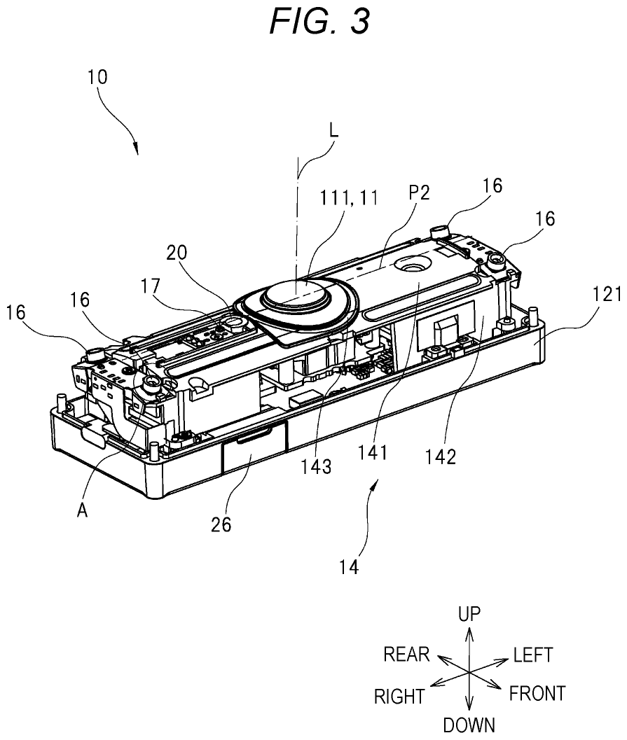

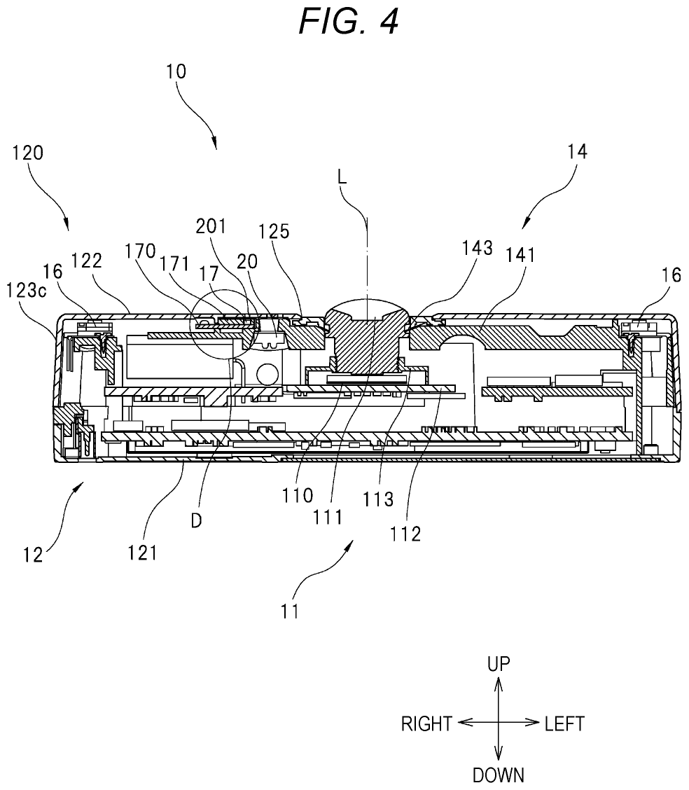

The top plate 122 of the front case 120 has multiple circular sound collecting openings 201 rightward from the case opening 125 on or around the first reference position P1. The sound collecting openings 201 are above a sound collector 20 described later (refer to FIGS. 3 and 4).

FIG. 2 is a perspective view of the front case 120 as viewed from below. The top plate 122 has an inner wall surface with a compartment 124 located rightward from the sound collecting openings 201. The compartment 124 is an inner area surrounded by walls 124a, 124b, and 124c protruding downward from the inner wall surface of the top plate 122. The wall 124a is located frontward from the first reference position P1 (refer to FIG. 1) and extends in the right-left direction. The wall 124c is located rearward from the first reference position P1 and extends in the right-left direction. A second light shield 171 is fitted and accommodated in the compartment 124. The second light shield 171 restricts entry of light into an illuminometer 17 (described later) through the side surface of the illuminometer 17.

The rear case 121 shown in FIG. 1 is fastened to the front case 120 and closes the bottom (downward) of the front case 120. The rear case 121 is fastened to the front case 120 with, for example, screws.

### Memory Slot 26

The imaging device 10 includes the memory slot 26 connectable to a predetermined storage medium. More specifically, the imaging device 10 includes a slot in which a secure digital (SD) memory card is removably placed. The SD memory card can be placed into or removed from the memory slot 26 after a lid in the rear case 121 is opened.

### Internal Structure of Imaging Device 10

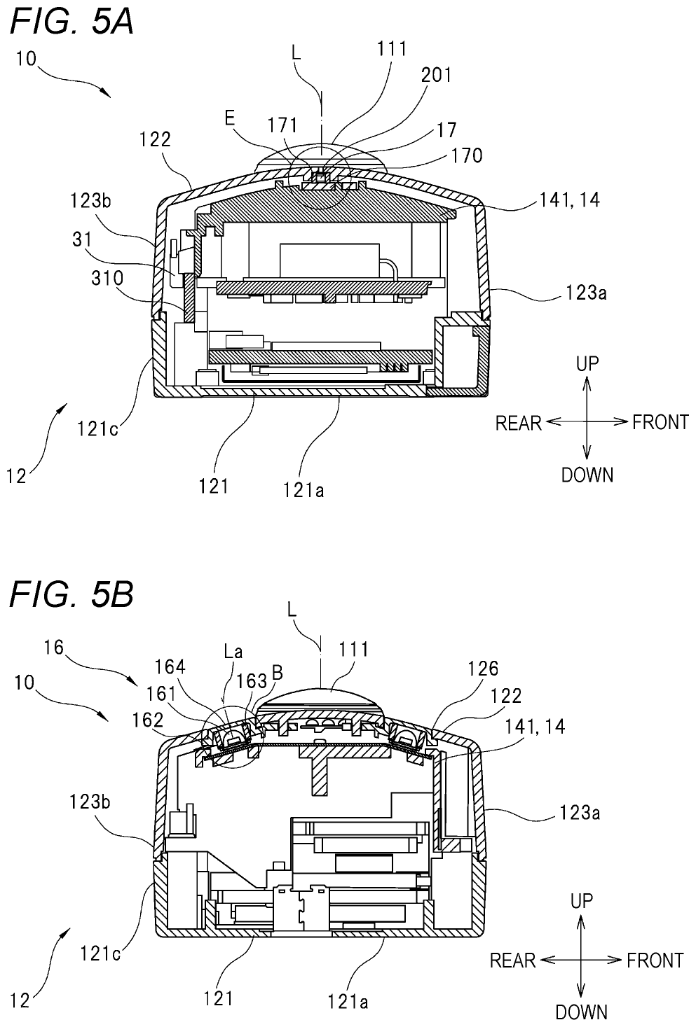

FIG. 3 is an internal perspective view of the imaging device 10 shown in FIG. 1. FIG. 4 is a cross-sectional view of the imaging device 10 taken along line A-A in FIG. 1. FIG. 5A is a cross-sectional view of the imaging device 10 taken along line B-B in FIG. 1. FIG. 5B is a cross-sectional view of the imaging device 10 taken along line C-C in FIG. 1. The imaging device 10 includes a support 14, the illuminometer 17, and the sound collector 20 in addition to the components described above.

### Camera Module 11

The camera module 11 includes an imaging element (image sensor) 110, such as a complementary metal-oxide-semiconductor (CMOS) or a charge-coupled device (CCD), and the lens 111. The imaging element 110 is mounted on a substrate 112 and accommodated in the housing 12. The lens 111 is located above the imaging element 110 and held by a lens holder 113. The lens 111 held by the lens holder 113 protrudes upward from the top plate 122 through the case opening 125 in the top plate 122 of the housing 12 described above. Below the lens holder 113, the substrate 112 on which the above imaging element 110 is mounted is fastened with, for example, screws.

The lens 111 guides and collects external subject light reaching the imaging device 10 to a light-receiving surface of the imaging element 110. In other words, the lens 111 is an optical member (imaging optical system) that forms an image of an imaging target on the light-receiving surface of the imaging element 110, or at least a part of the optical member. The imaging element 110 converts the brightness of light for the image formed by the lens 111 to electric charge and outputs a signal (image signal) corresponding to the resultant electric charge.

### Illuminator 16

The illuminators 16 are controlled by a controller 31 (described later) to emit illumination light to illuminate the imaging target (subject) for imaging in a dark surrounding external environment (or in the low-light imaging mode). The illuminators 16 are accommodated in the housing 12 and located below the illumination openings 126. Each illuminator 16 includes a substrate 160, an illumination light source 161, and a cover 162. The illumination light source 161 is located on the substrate 160. In other words, the substrate 160 functions as a support for the illumination light source 161. The illumination light source 161 includes, for example, a light-emitting diode (LED) chip and an optical member above the LED chip, and emits light with a wavelength in the infrared region (infrared rays or infrared light) under control of the controller 31. The illuminators 16 may not emit infrared light as illumination light, and may emit visible light other than infrared light.

The cover 162 is formed from, for example, a light-transmissive resin and is located above the illumination light source 161. The cover 162 has a surface 164 covering at least an upper portion of the illumination light source 161. More specifically, the cover 162 is located with the surface 164 being orthogonal or substantially orthogonal to an optical axis La of the illumination light source 161. The surface 164 of the cover 162 is fitted into the corresponding illumination opening 126. As described above, the illumination openings 126 are located in the surfaces of the top plate 122 inclined toward the middle portion. The optical axis L of the lens 111 thus extends in a direction not parallel to the optical axis La of the illumination light source 161 orthogonal or substantially orthogonal to the surface 164 of the cover 162. Illumination light emitted from the illumination light sources 161 is output from the imaging device 10 through the surfaces 164 of the covers 162. In other words, illumination light is emitted from the imaging device 10 through the illumination openings 126.

The illumination light source 161 is surrounded by a first light shield 163. The first light shield 163 will be described in detail later.

As shown in FIGS. 1 and 3, the imaging device 10 includes four illuminators 16. Of the four illuminators 16, a pair of illuminators 16 are located in a right portion of the support 14 (described later), with one illuminator 16 located at the front and the other at the rear. The other pair of illuminators 16 are located in a left portion of the support 14, with one illuminator 16 located at the front and the other at the rear.

The imaging device 10 may not include four illuminators 16. The imaging device 10 may include three or fewer illuminators 16 or five or more illuminators 16.

### Illuminometer 17

The illuminometer 17, which is, for example, a photoresistor or a photodiode, receives light reaching from the external environment surrounding the imaging device 10. The illuminometer 17 is mounted on a substrate 170 adjacent to a second reference position P2 (refer to FIG. 3) on the support 14 (described later). The substrate 170 is located rightward from the sound collector 20. The sound collector 20 includes a microphone for collecting sounds around the imaging device 10 through the sound collecting openings 201. More specifically, the illuminometer 17 is located below the rightmost one of the multiple sound collecting openings 201 in the top plate 122 of the front case 120. The illuminometer 17 receives external light through the rightmost sound collecting opening 201. The illuminometer 17 converts the brightness of the received external light to electric charge and outputs a signal (luminance signal) corresponding to the resultant electric charge. In other words, the illuminometer 17 detects the brightness of the external environment surrounding the imaging device 10. The illuminometer 17 is surrounded by the second light shield 171 that reduces entry of light other than external light into the illuminometer 17. The second light shield 171 will be described in detail later.

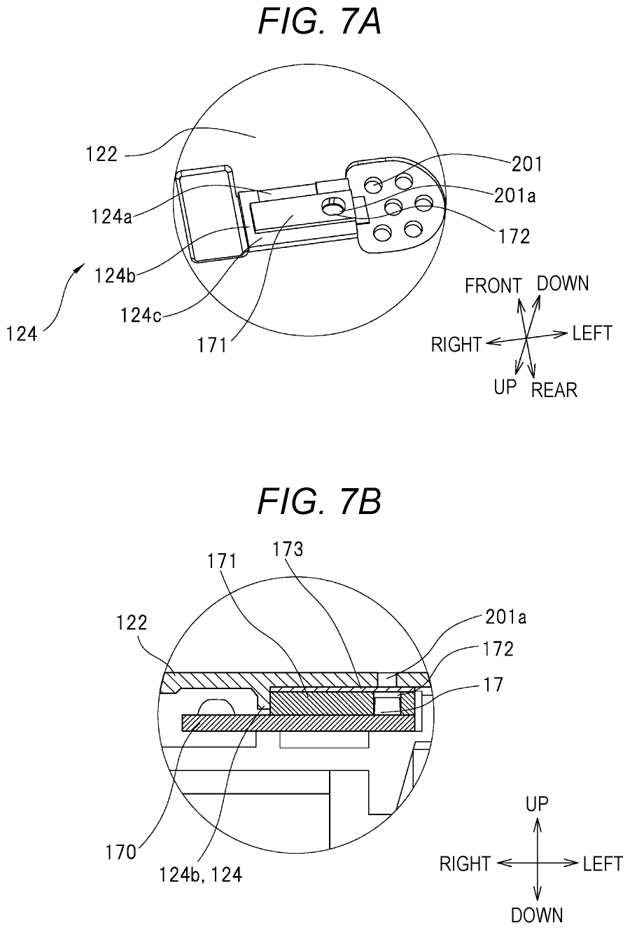

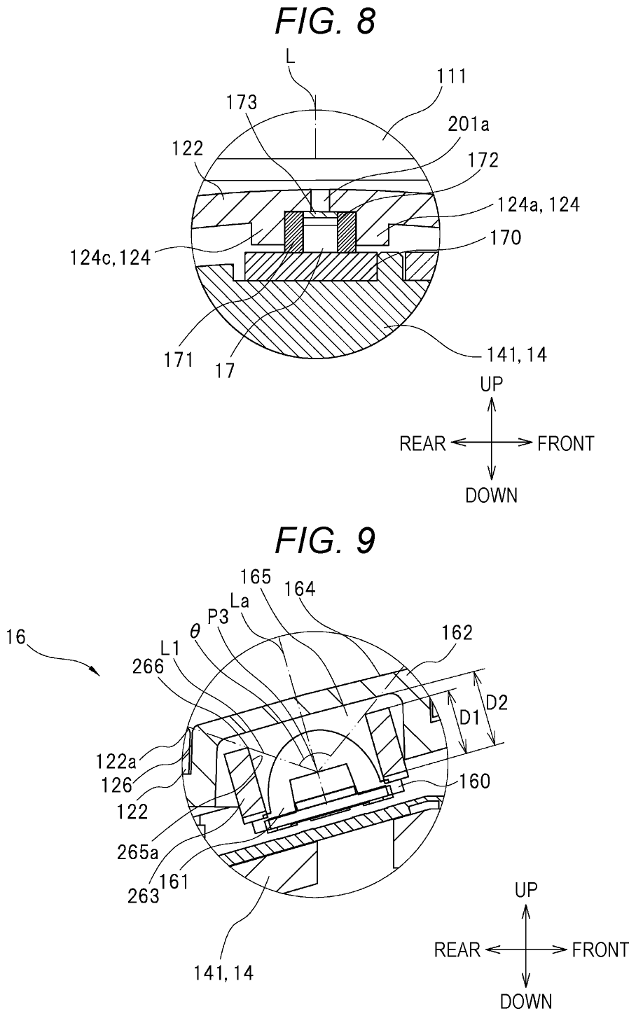

A light-transmissive filter 173 (refer to FIGS. 7B and 8) that transmits, for example, white light, is located between a light-receiving surface of the illuminometer 17 and the front case 120. The filter 173 transmits external light to allow the light to reach the illuminometer 17 and reduces dust or other matter entering the imaging device 10 through the sound collecting openings 201. The filter 173 may be a bandpass filter that allows light in an intended wavelength range to pass through. The bandpass filter used as the filter 173 allows light in a wavelength region for detecting the brightness of the surrounding external environment to pass through, thus allowing accurate detection of the brightness of the surrounding external environment. The filter 173 may be eliminated.

### Controller 31

The controller 31 is located at the rear in the housing 12 and mounted on a substrate 310. The controller 31 includes, for example, a central processing unit (CPU), a memory, and other components, and is electrically connected to the substrate 112 on which the imaging element 110 is mounted. The controller 31 is a processor that reads and executes a control program prestored in a storage medium, such as a flash memory, to control various components of the imaging device 10. For example, the controller 31 controls electric power supply from a power supply to various components including the imaging element 110.

Based on the luminance signal output from the illuminometer 17, the controller 31 sets the normal imaging mode when the external environment of the imaging device 10 is bright, and sets the low-light imaging mode when the external environment of the imaging device 10 is dark. In the low-light imaging mode, the controller 31 controls the illuminators 16 to emit illumination light to illuminate the subject with the illumination light when the external environment is dark and lacks a sufficient amount of light.

### Support 14

The support 14 is formed from, for example, a synthetic resin, and includes a main base 141 and a sub-base 142 integral with each other. The main base 141 is curved along or substantially along the curved front case 120. More specifically, the main base 141 is curved in the front-rear direction and protrudes most outward (upward) at the second reference position P2, which is on a line passing through a middle portion of the main base 141 (or a position through which the optical axis L of the lens 111 extends) and extending in the right-left direction. The second reference position P2 is parallel or substantially parallel to the first reference position P1 below the first reference position P1 of the front case 120 described above.

The sub-base 142 extends downward from the main base 141 and has a threaded hole to be fastened to the rear case 121 with a screw. The sub-base 142 is fastened to the rear case 121 with the screw. This fastens the support 14 to the rear case 121.

The main base 141 has a circular or substantially circular main base opening 143 vertically extending through the support 14 with the optical axis L of the lens 111 at the center. In other words, the main base opening 143 is a through-hole in the main base 141. The lens 111 is placed in the main base opening 143.

The illuminators 16, the illuminometer 17, and the sound collector 20 are mounted on the upper surface of the main base 141. The main base 141 receives two illuminators 16 in its right portion and two illuminators 16 in its left portion. More specifically, the main base 141 receives one illuminator 16 at each of the front near the left end, the rear near the left end, the front near the right end, and the rear near the right end. The main base 141 receives the illuminometer 17 and the sound collector 20 adjacent to the second reference position P2 and rightward from the main base opening 143.

As described above, the main base 141 is curved and protrudes most upward at the second reference position P2 in the front-rear direction. The illuminometer 17 is thus located more upward than the illuminators 16 on the main base 141. In other words, the illuminators 16 are farther from the subject than the illuminometer 17 along the optical axis L.

### First Light Shield 163

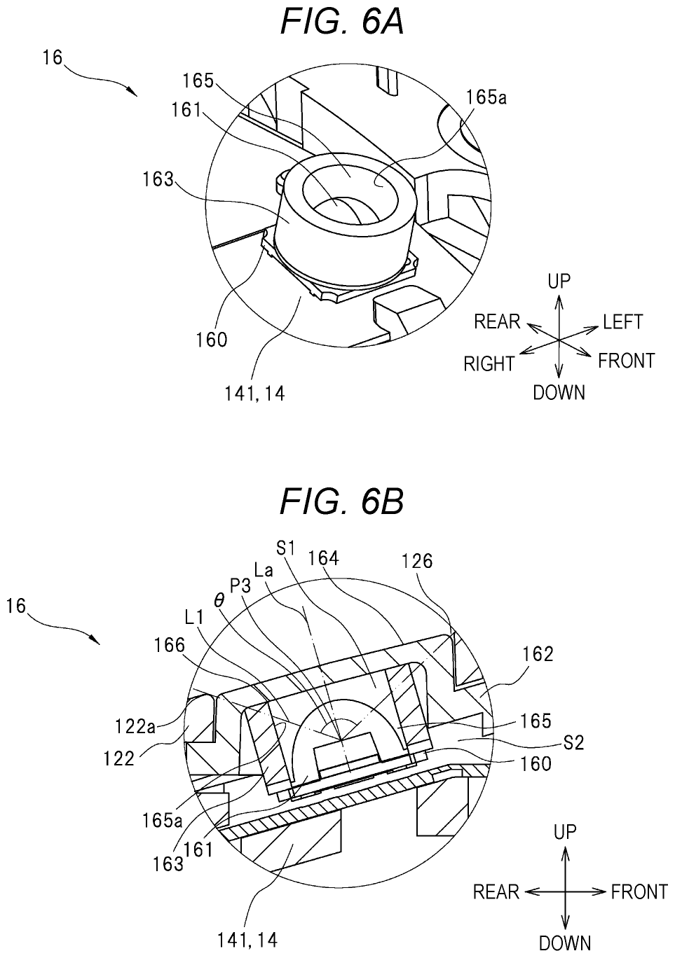

The first light shield 163 will be described with reference to FIGS. 6A and 6B. FIG. 6A is an enlarged view of circled area A in FIG. 3. FIG. 6B is an enlarged view of circled area B in FIG. 5B.

As illustrated in FIGS. 6A and 6B, the first light shield 163 surrounds the illumination light source 161 in the front-rear and right-left directions. The first light shield 163 extends in a direction along the optical axis La of the illumination light source 161. The first light shield 163 has a through-hole 165 extending through the first light shield 163 in the direction along the optical axis La of the illumination light source 161. In other words, the through-hole 165 has a wall surface 165a extending in the direction along the optical axis La. The illumination light source 161 is located inside the through-hole 165. The first light shield 163 is formed from an elastic material such as rubber or urethane. The first light shield 163 may have the wall surface 165a of the through-hole 165 as its inner wall surface coated with, for example, a light-absorbing material that absorbs light.

More specifically, the first light shield 163 is a cylinder. For example, the first light shield 163 is a cylindrical member having the through-hole 165 described above centered on the optical axis La of the illumination light source 161. The through-hole 165 is circular or substantially circular in a direction intersecting with the optical axis La. The through-hole 165 has a diameter greater than the diameter the illumination light source 161. In other words, the first light shield 163 has an inner diameter greater than the diameter of the illumination light source 161.

The first light shield 163 may not be a cylinder, but may be a polygonal prism, such as a rectangular prism, as appropriate for the position of the first light shield 163 or the positional relationships between the first light shield 163 and other members. The through-hole 165 may not be circular or substantially circular in the direction intersecting with the optical axis La, but may be polygonal, such as rectangular, as appropriate for the shape of the illumination light source 161 located inside the through-hole 165.

The first light shield 163 has its lower surface attached to an upper surface of the substrate 160 with, for example, an adhesive or double-sided tape. This attaches the first light shield 163 to the substrate 160. In other words, the first light shield 163 surrounds the illumination light source 161 on the substrate 160. The first light shield 163 has a length (height) in the direction along the optical axis La greater than a distance between the substrate 160 and the surface 164 of the cover 162 in the direction along the optical axis La. In response to the rear case 121 attached to the front case 120, the first light shield 163 formed from the elastic material contracts and deforms in the vertical direction under a force applied by the front case 120 from above and a force applied by the main base 141 from below through the substrate 160. More specifically, the wall surface 165a of the through-hole 165 fills a space between the front case 120 and the substrate 160 with a gap reduced between an upper surface of the first light shield 163 and the lower surface of the surface 164 of the cover 162. In other words, the wall surface 165a of the through-hole 165 divides the space between the housing 12 and the substrate 160 into a first space S1 receiving the illumination light source 161 and a second space S2 not receiving the illumination light source 161.

As described above, the gap between the first light shield 163 and the front case 120 is reduced. This allows the inner wall surface of the first light shield 163 (in other words, the wall surface 165a of the through-hole 165) to block a light flux of the illumination light emitted from the illumination light source 161 and traveling in a direction inclined at an angle greater than a predetermined diffusion angle θ with respect to the optical axis La. In other words, a light flux of the illumination light emitted from the illumination light source 161 and traveling in a direction inclined at less than the diffusion angle θ passes through the cover 162 and the illumination opening 126 to be output from the imaging device 10 to illuminate the subject.

When traveling in the direction inclined at the diffusion angle θ, the illumination light can be output from the imaging device 10 without vignetting being caused by the inner wall surface of the illumination opening 126 (in other words, the front case 120). More specifically, the diffusion angle θ corresponds to an area surrounded by a diffusion limit line L1 connecting an upper end 122a of the inner wall surface of the corresponding illumination opening 126 and an emission point P3 at which the light flux is emitted from the illumination light source 161. The wall surface 165a of the first light shield 163 has its upper end surface 166 placed inward from the diffusion limit line L1. This structure allows the first light shield 163 to block the light flux emitted from the illumination light source 161 and traveling in a direction inclined at an angle greater than an angle defined by the diffusion limit line L1, or specifically, to block the light flux traveling in a direction in which vignetting is caused by the front case 120. The light flux thus does not travel outside the first light shield 163. Thus, the first light shield 163 reduces the likelihood that the illumination light emitted from the illumination light source 161 is diffusely reflected by the lower surface of the front case 120 or the various internal components of the imaging device 10 and enters the imaging element 110 or the illuminometer 17.

### Second Light Shield 171

The second light shield 171 will be described with reference to FIGS. 7A, 7B, and 8. FIG. 7A is an enlarged view of circled area C in FIG. 2. FIG. 7B is an enlarged view of circled area D in FIG. 4. FIG. 8 is an enlarged view of circled area E in FIG. 5A.

As shown in the figures, the second light shield 171 surrounds the illuminometer 17 in the front-rear and right-left directions. The second light shield 171 is formed from an elastic material such as rubber or urethane. The second light shield 171 may have surfaces coated with, for example, a light-absorbing material that absorbs light. The second light shield 171 has a through-hole 172 extending through the second light shield 171 in the vertical direction aligned with the position at which the illuminometer 17 is placed. Thus, the second light shield 171 surrounds the illuminometer 17.

The second light shield 171 is a rectangular prism corresponding to the shape of the compartment 124, with its long sides extending in the right-left direction. The second light shield 171 is not limited to a rectangular prism, and may be, for example, a cube. The second light shield 171 is attached to the compartment 124, or more specifically, to the inner wall surface of the top plate 122 of the front case 120, with, for example, an adhesive or double-sided tape. The second light shield 171 that can be placed at the above position and bonded sufficiently firmly may have a shape with a larger upper surface to have a larger area of bonding to the top plate 122.

The second light shield 171 has a length (height) in a direction along the optical axis L, or in the vertical direction, greater than the length (height) of the walls 124a, 124b, and 124c of the compartment 124 in the vertical direction. More specifically, the second light shield 171 has a height greater than the distance in the vertical direction between the inner wall surface (lower surface) of the top plate 122 of the front case 120 and the substrate 170 on the main base 141 in the support 14. In response to the rear case 121 attached to the front case 120, the second light shield 171 formed from an elastic material contracts and deforms in the vertical direction under a force applied by the front case 120 from above and a force applied, from below, by the substrate 170 on which the illuminometer 17 is mounted. More specifically, the second light shield 171 fills the space around the side surface of the illuminometer 17 between the front case 120 and the substrate 170 with a gap reduced between the lower surface of the second light shield 171 and the upper surface of the substrate 170. With the reduced gap between the second light shield 171 and the substrate 170, the second light shield 171 can block light traveling toward the illuminometer 17 in the lateral direction of the illuminometer 17.

The illuminators 16 are located downward from the illuminometer 17. Thus, when some illumination light emitted from the illuminators 16 enters the imaging device 10, the second light shield 171 reduces the likelihood that the light reflected by various internal components of the imaging device 10 enters the illuminometer 17 in the lateral direction. This allows the illuminometer 17 to receive external light entering through the front surface of (from above) the imaging device 10 and thus detect the brightness of the surrounding external environment accurately.

With the second light shield 171 accommodated in the compartment 124 on the front case 120, the through-hole 172 is below the rightmost sound collecting opening 201a of the multiple sound collecting openings 201. In other words, the through-hole 172 is at the position at which the illuminometer 17 is located. The illuminometer 17 thus receives external light passing through the sound collecting opening 201a through the through-hole 172. The through-hole 172 blocks, on its side wall surface, external light obliquely entering the illuminometer 17, or more specifically, light traveling in a direction not parallel to the optical axis L of the lens 111. The illuminometer 17 thus does not receive such light. In other words, the through-hole 172 allows external light traveling along the optical axis L to pass through. The illuminometer 17 can thus receive external light entering through the front surface of (from above) the imaging device 10. The through-hole 172 may not be below the sound collecting opening 201a, and may be, in the second light shield 171, below at least one of the multiple sound collecting openings 201.

The through-hole 172 is an elongated hole. The through-hole 172 has a minor axis with a length equal to or substantially equal to the diameter of the sound collecting opening 201a that is a circular hole. The through-hole 172 has a major axis with a length greater than the diameter of the sound collecting opening 201a. The through-hole 172 is larger than a light receiver in the illuminometer 17. The second light shield 171 attached at a position misaligned in the right-left direction with respect to the top plate 122 of the front case 120 during manufacture is thus less likely to close the sound collecting opening 201a.

In FIG. 7A, the through-hole 172 has a major axis extending in the right-left direction. However, the through-hole 172 may have a major axis extending in the front-rear direction or in any other direction, rather than in the direction in the illustrated example. More specifically, the through-hole 172 may have a major axis extending in a direction in which the second light shield 171 may be misaligned during attachment. The through-hole 172 may be a circular hole with a larger diameter than the sound collecting opening 201a to reduce the likelihood that the second light shield 171 closes the sound collecting opening 201a. The through-hole 172 may be a circular hole similar to the sound collecting opening 201a instead of an elongated hole when the second light shield 171 can be attached to the front case 120 without any misalignment between the through-hole 172 and the sound collecting opening 201a.

The structure according to the above embodiment produces at least one of the advantageous effects described below.

(1) The imaging device 10 includes the first light shields 163 each surrounding the corresponding illumination light source 161 on the substrate 160 as the support. Each first light shield 163 has the through-hole 165 to receive the illumination light source 161. The through-hole 165 extends in the direction along the optical axis La of the illumination light source 161. The wall surface 165a of the through-hole 165 blocks a part of the light flux emitted from the illumination light source 161. This allows the first light shield 163 to block the light flux emitted from the illumination light source 161 and traveling in the direction in which vignetting is caused by the portion of the front case 120 defining the corresponding illumination opening 126. The light flux thus does not travel outside the first light shield 163. This reduces the likelihood that the illumination light emitted from the illumination light source 161 is diffusely reflected by the lower surface of the front case 120 or the various internal components of the imaging device 10 and enters the other devices including light-receiving sensors such as the imaging element 110. In other words, the quality of images captured and generated by the imaging element 110 is less likely to decrease. The detection accuracy of each light-receiving sensor is less likely to decrease. This structure also has less limitation on the positions of the illuminators 16 with respect to the other devices including light-receiving sensors, thus increasing the design flexibility.

(2) The wall surface 165a of the first light shield 163 blocks the light flux emitted from the illumination light source 161 and traveling in the direction inclined at an angle greater than the diffusion angle θ with respect to the optical axis La. A light flux emitted from the illumination light source 161 and traveling outside the diffusion limit line L1 corresponds to the light flux traveling in the direction in which vignetting is caused by the front case 120. Such light fluxes are blocked by the wall surface 165a of the first light shield 163 and do not travel outside the first light shield 163. This reduces the likelihood that the illumination light emitted from the illumination light source 161 is diffusely reflected by the lower surface of the front case 120 or the various internal components of the imaging device 10 and enters the other devices including light-receiving sensors such as the imaging element 110.

(3) The wall surface 165a divides the space between the housing 12 and the substrate 160 as the support into the first space S1 receiving the illumination light source 161 and the second space S2 not receiving the illumination light source 161. This structure reduces the likelihood that a light flux traveling in the direction in which vignetting is caused by the front case 120 and entering the imaging device 10 travels outside the first light shield 163. Thus, the other devices including light-receiving sensors such as the imaging element 110 are less susceptible to the illumination light emitted from the illumination light source 161.

(4) The illuminometer 17 in the imaging device 10 is accommodated in the housing 12 to receive external light through the sound collecting opening 201a in the housing 12 and detect the brightness of the surrounding environment. The second light shield 171 in the imaging device 10 surrounds the illuminometer 17 and fills the space between the substrate 170 on which the illuminometer 17 is mounted and the housing 12 to block light. This structure reduces a gap between the second light shield 171 and the substrate 170, thus allowing the second light shield 171 to block light traveling toward the illuminometer 17 in the lateral direction of the illuminometer 17. In other words, this structure reduces the likelihood that the illuminometer 17 receives light emitted by other devices in the housing 12 and reflected by the internal components in the housing 12. The illuminometer 17 is thus less susceptible to ambient light and can have higher accuracy in detecting the brightness of the surrounding external environment. This structure has less limitation on the positions of devices that emit light, thus increasing the design flexibility.

(5) The illuminators 16 emit illumination light to illuminate a subject. Each illuminator 16 is farther from the subject than the illuminometer 17 along the optical axis L of the lens 111. In other words, the illuminators 16 are located downward from the illuminometer 17. The second light shield 171 reduces the likelihood that illumination light emitted from the illuminators 16, which are located downward from the illuminometer 17, and diffusely reflected by the various internal components of the imaging device 10 enters the illuminometer 17 in the lateral direction of the illuminometer 17. This structure can thus increase the positioning flexibility of the illuminators 16. The increased positioning flexibility of the illuminators 16 reduces limitation on the positions of the other devices and components in the imaging device 10, thus increasing the design flexibility.

(6) Each of the first light shield 163 and the second light shield 171 is formed from an elastic material. The first light shield 163 accommodated in the housing 12 contracts and deforms in the vertical direction under the force applied by the front case 120 from above and the force applied by the substrate 160 from below. This defines the first space S1 and the second space S2 without a gap and thus reduces the likelihood that the light flux entering the imaging device 10 travels outside the first light shield 163. The second light shield 171 accommodated in the housing 12 easily deforms to correspond to the shapes of the top plate 122 of the front case 120 and the substrate 170. Thus, for the curved top plate 122, the second light shield 171 can be located in tight contact with the top plate 122 of the front case 120 and the substrate 170.

(7) The second light shield 171 has a length in the direction along the optical axis L (vertical direction) greater than the distance between the lower surface of the top plate 122 of the front case 120 in the housing 12 and the substrate 170 in the direction along the optical axis L (vertical direction). The second light shield 171 attached to the front case 120 and accommodated in the housing 12 is deformed by the top plate 122 of the housing 12 and the substrate 170 in the direction along the optical axis L (vertical direction). The second light shield 171 is thus located in tight contact with the top plate 122 and the substrate 170 and fills the space around the illuminometer 17 between the substrate 170 and the top plate 122 without a gap. This allows the second light shield 171 to block light traveling toward the illuminometer 17 in the lateral direction of the illuminometer 17. The illuminometer 17 is thus less susceptible to ambient light and can have higher accuracy in detecting the brightness of the external environment.

(8) The second light shield 171 has the through-hole 172 through which external light passes after passing through the sound collecting opening 201a. This structure allows the illuminometer 17 to receive external light and detect the brightness of the surrounding external environment, with entry of less ambient light.

(9) The through-hole 172 is an elongated hole. Thus, for the second light shield 171 attached at a position misaligned in the right-left direction with respect to the top plate 122 of the front case 120 during manufacture, the second light shield 171 is less likely to close the sound collecting opening 201a.

(10) The through-hole 172 allows external light traveling in the direction along the optical axis L to pass through. The illuminometer 17 can thus receive external light entering through the front surface of (from above) the imaging device 10.

(11) The light-transmissive filter 173 is located between the top plate 122 of the front case 120 in the housing 12 and the illuminometer 17. This structure can reduce dust or other matter entering the imaging device 10 through the sound collecting opening 201a without preventing external light from reaching the illuminometer 17.

### First Modification

Illuminators 16 in an imaging device 10 according to a first modification each include a first light shield having a shape different from the shape of the first light shield 163 in the embodiment. Unlike the first light shield 163 in the embodiment, the first light shield in the first modification has a length (height) in the direction along the optical axis La less than the distance between the substrate 160 and the surface 164 of the cover 162 in the direction along the optical axis La. These members will now be described in detail.

FIG. 9 is, similarly to FIG. 6B, an enlarged cross-sectional view of a first light shield 263 in the first modification and the corresponding illumination light source 161. The first light shield 263 has a length D1 in the direction along the optical axis La less than a distance D2 between the substrate 160 and the surface 164 of the cover 162 in the direction along the optical axis La. The length D1 of the first light shield 263 is defined based on the diffusion angle θ. More specifically, the first light shield 263 has an upper end 266 of its wall surface 265a on the diffusion limit line L1 connecting the upper end 122a of the inner wall surface of the corresponding illumination opening 126 and the emission point P3 of the illumination light.

This allows the wall surface 265a of the first light shield 263 to block the light flux traveling in the direction inclined at an angle greater than the diffusion angle θ with respect to the optical axis La. As in the embodiment, this reduces the likelihood that the illumination light emitted from the illumination light source 161 is diffusely reflected by the lower surface of the front case 120 or the various internal components of the imaging device 10 and enters the imaging element 110 or the illuminometer 17. In other words, this structure produces the same advantageous effects (1) and (2) as the structure according to the above embodiment. With the upper end 266 of the first light shield 263 on the diffusion limit line L1, the first light shield 263 is less likely to block a part of the illumination light expected to be emitted outside the imaging device 10. Thus, the amount of illumination light is less likely to decrease.

### Second Modification

Illuminators 16 in an imaging device 10 according to a second modification each include a first light shield having a shape different from the shape of the first light shield 163 in the embodiment or the shape of the first light shield 263 in the first modification. The first light shield in the second modification has a surface intersecting with the optical axis La upward from the corresponding illumination light source 161, and the surface has a light source opening. These members will now be described in detail.

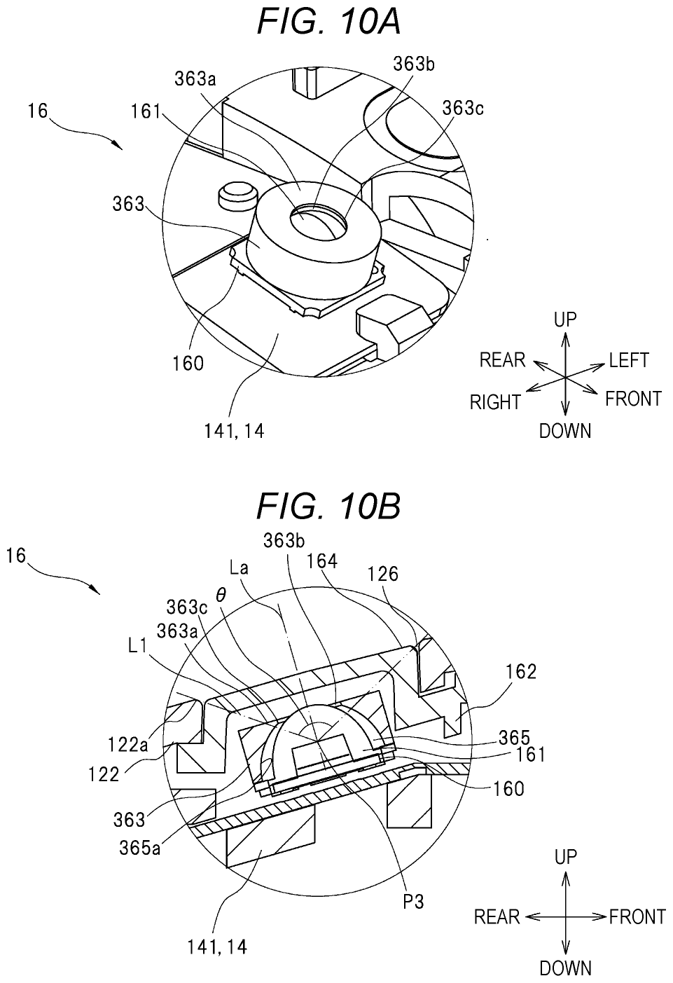

FIG. 10A is an external perspective view of a first light shield 363 according to the second modification. FIG. 10B is, similarly to FIG. 6B, an enlarged cross-sectional view of the first light shield 363 in the second modification and the corresponding illumination light source 161.

The first light shield 363 has, at its upper end (in other words, closer to the subject than the substrate 160), a covering surface 363a on a plane intersecting with the optical axis La. Similarly to the first light shield 263 in the first modification, the first light shield 363 has a length in the direction along the optical axis La less than the distance between the main base 141 and the surface 164 of the cover 162 in the direction along the optical axis La. In other words, the covering surface 363a at the upper end of the first light shield 363 is not in contact with the surface 164 of the cover 162.

The covering surface 363a has, as an opening at one end (upper end) of a through-hole 365, a circular or substantially circular light source opening 363b centered on the optical axis La of the illumination light source 161. As illustrated in FIG. 10B, the light source opening 363b has an inner diameter smaller than the inner diameter of the through-hole 365 in a lower portion. The through-hole 365 has the inner diameter, in the lower portion, defined based on the diameter of the illumination light source 161. This structure allows the covering surface 363a to cover a part of the upper portion of the illumination light source 161.

The light source opening 363b has a size defined based on the diffusion angle θ of the illumination light. More specifically, the light source opening 363b has an upper end 363c of its inner wall surface located inside the area surrounded by the diffusion limit line L1. This allows the wall surface 365a of the through-hole 365 as the inner wall surface of the first light shield 363 to block the light flux traveling in the direction inclined at an angle greater than the diffusion angle θ with respect to the optical axis La.

The structure according to the second modification produces the advantageous effects described below, in addition to those in the above embodiment.

The first light shield 363 has the covering surface 363a closer to the subject than the substrate 160 to cover a part of the upper portion of the illumination light source 161. The covering surface 363a has the light source opening 363b to allow the light flux emitted from the illumination light source 161 to pass through to illuminate the subject. As in the embodiment and the first modification, this reduces the likelihood that the illumination light emitted from the illumination light source 161 is diffusely reflected by the lower surface of the front case 120 or the various internal components of the imaging device 10 and enters the imaging element 110 or the illuminometer 17.

The upper end 363c of the light source opening 363b may be located on the diffusion limit line L1. In this case, the first light shield 363 is less likely to block a part of the illumination light expected to be emitted outside the imaging device 10. Thus, the amount of illumination light emitted outside the imaging device 10 is less likely to decrease.

In FIG. 10B, the wall surface 365a of the through-hole 365 has a curved shape in the direction along the optical axis La in conformance with the outer shape of the optical member in the illumination light source 161, but may have other shapes. Similarly to the first light shield 163 in the embodiment and the first light shield 263 in the first modification, the wall surface 365a of the through-hole 365 may have a linear shape in the direction along the optical axis La.

The through-hole 365 may not be circular or substantially circular in the direction intersecting with the optical axis La, but may be polygonal, such as rectangular, as appropriate for the shape of the illumination light source 161 located inside the through-hole 365. In other words, the light source opening 363b may be polygonal, such as rectangular, as appropriate for the shape of the illumination light source 161.

### Third Modification

Illuminators 16 in an imaging device 10 according to a third modification each include a first light shield having a shape different from the shape of the first light shield 163, 263, or 363 (described above). The first light shield in the third modification includes a reflector above the first light shield 363 in the second modification. The reflector reflects the illumination light emitted from the corresponding illumination light source 161. These members will now be described in detail.

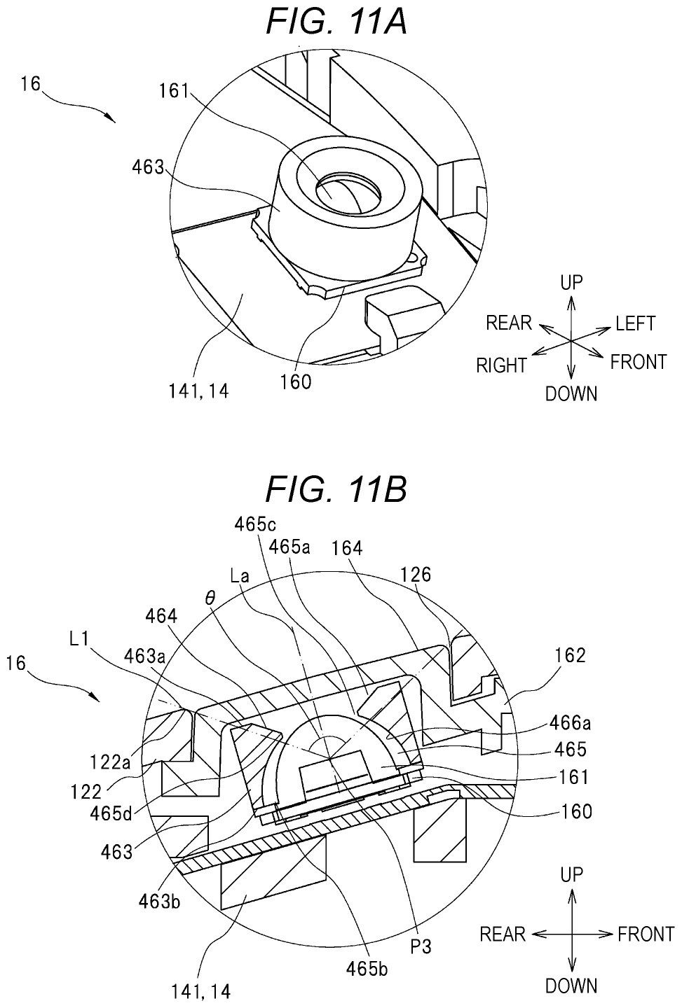

FIG. 11A is an external perspective view of a first light shield 463 in the third modification. FIG. 11B is, similarly to FIG. 6B, an enlarged cross-sectional view of the first light shield 463 in the third modification and the corresponding illumination light source 161.

The first light shield 463 is cylindrical and has a through-hole 465 extending in the direction along the optical axis La of the illumination light source 161. The through-hole 465 is circular or substantially circular and centered on the optical axis La in a plane intersecting with (orthogonal or substantially orthogonal to) the optical axis La. The through-hole 465 has, along the optical axis La, a first opening 465a, a second opening 465b, and a third opening 465c each with a different inner diameter. The first opening 465a is located in an upper end surface 463a as an upper end surface of the first light shield 463. The second opening 465b is located in a lower end surface 463b as a lower end surface of the first light shield 463. The third opening 465c is located between the first opening 465a and the second opening 465b in the direction along the optical axis La.

The inner diameter of the third opening 465c is smaller than the inner diameter of each of the first opening 465a and the second opening 465b. Similarly to the size of the light source opening 363b in the second modification, the third opening 465c has a size defined based on the diffusion angle θ of the illumination light. More specifically, the third opening 465c has an upper end 465d of its inner wall surface located inside the area surrounded by the diffusion limit line L1. In other words, the third opening 465c corresponds to the light source opening 363b in the second modification.

As a wall surface of the through-hole 465, a wall surface 466a having a curved shape in conformance with the outer shape of the optical member in the illumination light source 161 connects the second opening 465b and the third opening 465c in the direction along the optical axis La. In other words, the first light shield 463 has the same shape as the first light shield 363 in the second modification downward from the third opening 465c. This structure allows the light flux emitted from the illumination light source 161 and traveling in the direction inclined at an angle greater than the diffusion angle θ with respect to the optical axis La to be blocked by the wall surface 466a and the light flux emitted from the illumination light source 161 and traveling in the direction inclined at less than the diffusion angle θ with respect to the optical axis La to pass through the third opening 465c.

As another wall surface of the through-hole 465, an inclined surface 464 inclined with respect to the optical axis La connects the first opening 465a and the third opening 465c. The inclined surface 464 has a reflective surface on which metal, such as aluminum, is deposited. In some embodiments, the inclined surface 464 may be formed from a metal material. The inclined surface 464 reflects the light flux emitted from the illumination light source 161 and passing through the third opening 465c. In other words, the inclined surface 464 functions as the reflector to reflect the light flux passing through the third opening 465c.

As described above, the first light shield 463 has the same shape as the first light shield 363 in the second modification downward from the third opening 465c. Thus, the reflector is located above the first light shield 363 in the second modification (in other words, closer to the subject than the covering surface 363a of the first light shield 363).

The structure according to the third modification produces the advantageous effects described below, in addition to those in the above embodiment.

The first light shield 463 has the inclined surface 464 as a reflective surface above the covering surface 363a in the second modification, or in other words, closer to the subject than the covering surface 363a. The reflective surface reflects the light flux passing through the third opening 465c, which corresponds to the light source opening 363b in the covering surface 363a in the second modification, toward the subject. Thus, when a part of the illumination light emitted from the illumination light source 161 is blocked by the first light shield 463, the inclined surface 464 directs the illumination light toward the subject. The amount of illumination light illuminating the subject is less likely to decrease.

The through-hole 465 may not be circular or substantially circular in the direction intersecting with the optical axis La, but may be polygonal, such as rectangular, based on the shape of the illumination light source 161 located inside the through-hole 465. In other words, the first opening 465a, the second opening 465b, or the third opening 465c may be polygonal, such as rectangular, based on the shape of the illumination light source 161.

Although various embodiments and modifications are described above, the present invention is not limited to the embodiments and the modifications. Other forms implementable within the scope of technical idea of the present invention fall within the scope of the present invention.

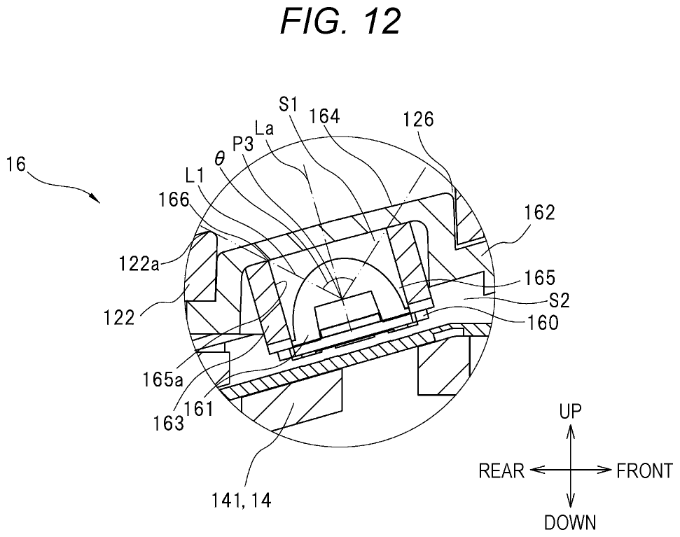

In the embodiment, the first light shield 163 has the upper end surface 166 of the wall surface 165a inside the diffusion limit line L1, but the present invention may not be limited to the embodiment. For example, as illustrated in the cross-sectional view in FIG. 12, the first light shield 163 may have the upper end surface 166 of the wall surface 165a on the diffusion limit line L1 as appropriate for, for example, the distance between the substrate 160 and the surface 164 of the cover 162 or the size of illumination openings 126. In other words, the upper end surface 166 of the first light shield 163 may be in contact with the surface 164 of the cover 162 and located on the diffusion limit line L1. This structure produces the advantageous effects (1) to (3) as the structure according to the above embodiment.

The imaging device 10 may not include the second light shield 171 surrounding the illuminometer 17. In this structure as well, the first light shield 163 blocks the light flux of the illumination light emitted from the illumination light source 161 and traveling in the direction inclined at an angle greater than the diffusion angle θ. Thus, the first light shield 163 reduces the likelihood that the illumination light is diffusely reflected by the internal components of the imaging device 10 and enters the imaging element 110 or the illuminometer 17. In other words, this structure produces the advantageous effect that is the same as at least one of the advantageous effects (1) to (3) produced by the structure according to the above embodiment.

The imaging device 10 may not include the illuminometer 17.

The second light shield 171 may be attached to the substrate 170 instead of being attached to the front case 120. In this structure as well, the second light shield 171 may have a shape with a larger lower surface to have a larger area of bonding to the substrate 170. The second light shield 171 may not be attached with its long sides extending in the right-left direction. For example, the second light shield 171 may be attached with the long sides extending in the front-rear direction. The second light shield 171 may be attached in a direction appropriate for the positional relationship with the other components in the housing 12.

The technique according to one or more embodiments of the present invention may provide the structure described below.

(1) An imaging device, comprising:
an imaging element configured to receive subject light through an optical member;
an illuminator including an illumination light source configured to emit illumination light to illuminate a subject, and a support on which the illumination light source is located; and
a first light shield surrounding the illumination light source on the support,
wherein the first light shield has a through-hole receiving the illumination light source,
the through-hole extends in a direction along an optical axis of the illumination light source, and
the through-hole has a wall surface to block a part of the illumination light emitted by the illumination light source.

(2) The imaging device according to (1), wherein
the wall surface blocks a light flux emitted from the illumination light source and traveling in a direction inclined at an angle greater than a predetermined angle with respect to the optical axis of the illumination light source.

(3) The imaging device according to (1) or (2), further comprising:
a housing accommodating the imaging element, the illumination light source, the support, and the first light shield,
wherein the wall surface divides a space between the housing and the support into a first space receiving the illumination light source and a second space not receiving the illumination light source.

(4) The imaging device according to any one of (1) to (3), wherein
the first light shield has a covering surface closer to the subject than the support, and the covering surface covers a part of the illumination light source, and
the covering surface has an illumination light source opening to allow a light flux emitted from the illumination light source to pass through to illuminate the subject.

(5) The imaging device according to (4), wherein
the first light shield includes a reflector closer to the subject than the covering surface, and the reflector reflects the light flux passing through the illumination light source opening toward the subject.

(6) The imaging device according to (3), further comprising:
an illuminometer accommodated in the housing, the illuminometer being configured to receive external light through an opening in the housing and detect brightness of a surrounding environment; and
a second light shield surrounding the illuminometer, the second light shield filling a space between a substrate on which the illuminometer is mounted and the housing to block light.

(7) The imaging device according to (6), wherein
the illumination light source is farther from the subject than the illuminometer in a direction along an optical axis of the optical member.

(8) The imaging device according to (6) or (7), wherein
each of the first light shield and the second light shield comprises an elastic material.

(9) The imaging device according to any one of (6) to (8), wherein
the second light shield has a length in a direction along an optical axis of the optical member greater than a distance between the housing and the substrate in the direction along the optical axis of the optical member, and
the second light shield accommodated in the housing is deformed by the housing and the substrate in the direction along the optical axis of the optical member.

(10) The imaging device according to any one of (6) to (9), wherein
the second light shield has a through-hole to allow external light passing through the opening in the housing to pass through.

(11) The imaging device according to (10), wherein
the through-hole in the second light shield is an elongated hole.

(12) The imaging device according to (10) or (11), wherein
the through-hole in the second light shield allows external light traveling in a direction along an optical axis of the optical member to pass through.

(13) The imaging device according to any one of (6) to (12), further comprising:
a light-transmissive filter between the housing and the illuminometer.

What is claimed is:

1. An imaging device, comprising:
an imaging element configured to receive subject light through an optical member;
an illuminator including an illumination light source configured to emit illumination light to illuminate a subject, and a support on which the illumination light source is located; and
a first light shield surrounding the illumination light source on the support,
wherein the first light shield has a through-hole receiving the illumination light source,
the through-hole extends in a direction along an optical axis of the illumination light source, and
the through-hole has a wall surface to block a part of the illumination light emitted by the illumination light source.

2. The imaging device according to claim 1, wherein
the wall surface blocks a light flux emitted from the illumination light source and traveling in a direction inclined at an angle greater than a predetermined angle with respect to the optical axis of the illumination light source.

3. The imaging device according to claim 1, further comprising:
a housing accommodating the imaging element, the illumination light source, the support, and the first light shield,
wherein the wall surface divides a space between the housing and the support into a first space receiving the illumination light source and a second space not receiving the illumination light source.

4. The imaging device according to claim 2, wherein
the first light shield has a covering surface closer to the subject than the support, and the covering surface covers a part of the illumination light source, and
the covering surface has an illumination light source opening to allow a light flux emitted from the illumination light source to pass through to illuminate the subject.

5. The imaging device according to claim 4, wherein
the first light shield includes a reflector closer to the subject than the covering surface, and the reflector reflects the light flux passing through the illumination light source opening toward the subject.

6. The imaging device according to claim 3, further comprising:
an illuminometer accommodated in the housing, the illuminometer being configured to receive external light through an opening in the housing and detect brightness of a surrounding environment; and
a second light shield surrounding the illuminometer, the second light shield filling a space between a substrate on which the illuminometer is mounted and the housing to block light.

7. The imaging device according to claim 6, wherein
the illumination light source is farther from the subject than the illuminometer in a direction along an optical axis of the optical member.

8. The imaging device according to claim 6, wherein
each of the first light shield and the second light shield comprises an elastic material.

9. The imaging device according to claim 6, wherein
the second light shield has a length in a direction along an optical axis of the optical member greater than a distance between the housing and the substrate in the direction along the optical axis of the optical member, and
the second light shield accommodated in the housing is deformed by the housing and the substrate in the direction along the optical axis of the optical member.

10. The imaging device according to claim 6, wherein
the second light shield has a through-hole to allow external light passing through the opening in the housing to pass through.

11. The imaging device according to claim 10, wherein
the through-hole in the second light shield is an elongated hole.

12. The imaging device according to claim 10, wherein
the through-hole in the second light shield allows external light traveling in a direction along an optical axis of the optical member to pass through.

13. The imaging device according to claim 6, further comprising:
a light-transmissive filter between the housing and the illuminometer.
